(19) United States
(12) Patent Application Publication
(10) Pub. No.: US 2005/0028529 A1
(43) Pub. Date: Feb. 10, 2005

(54) Method of generating energy in a power plant comprising a gas turbine, and power plant for carrying out the method

(76) Inventors: Michael Adam Bartlett, Farsta (SE); Timothy Griffin, Ennetbaden (CH); Daniel Holmberg, Aengelholm (SE)

Correspondence Address: CERMAK & KENEALY LLP, P.O. BOX 7518, ALEXANDRIA, VA, 22307, US

(21) Appl. No.: 10/855,494

(22) Filed: May 28, 2004

(30) Foreign Application Priority Data
Jun. 2, 2003 (DE) 103 25 111.1

(51) Int. Cl. F02C 1/00

(52) U.S. Cl. 60/772; 60/39.52

(57) ABSTRACT

A method of generating energy in a power plant (30) having a gas turbine (29), includes a first step a gas containing air (1) is compressed in a first compressor (2) of the gas turbine (29), a second step the compressed gas (3, 3a, 3b; 5; 7a, 7b) is fed to a combustion process with the addition of fuel (8) in a combustor (23), a third step the hot flue gas (9) from the combustor (23) is expanded in an expander or a turbine (10), driving a generator (18), of the gas turbine (29) while performing work, and a fourth step a partial flow of the expanded flue gas (11) is recirculated to the inlet of the first compressor (2) and admixed with the gas containing air (1). Carbon dioxide (CO₂) is separated from the compressed gas (3, 3a, 3b; 5; 7a, 7b) in a CO₂ separator (6) before the third step. In such a method, the overall size and energy costs are reduced by virtue of the fact that, to permit increased CO₂ concentrations in the CO₂ separator (6), not more than about 70% of the carbon dioxide contained in the compressed gas (3, 3a, 3b; 5, 5a, 5b; 7a, 7b) is removed from the compressed gas (3, 3a, 3b; 5, 5a, 5b; 7a, 7b).

This application claims priority under 35 U.S.C. § 119 to German application number 103 25 111.1, filed 02 Jun. 2003, the entirety of which is incorporated by reference herein.

### BACKGROUND OF THE INVENTION

1. Field of the Invention

The present invention relates to the field of energy generation technology. It relates to a method of generating energy and to a power plant for carrying out the method.

Such a method and such a plant have been disclosed, for example, by WO-A1-02/103176.

2. Brief Description of the Related Art

During the last decade the interest in environmentally compatible power stations with low emissions has increased considerably. As an answer to the possibly restricted economy with regard to the carbon, the possibility of generating energy from fossil fuels with low carbon dioxide emission is of particular interest. Various projects have already been started with the aim of developing gas-turbine-based processes with low emission. There are three conventional ways of reducing the CO₂ emission from such power stations:
1. Methods of capturing the CO₂ on the output side: in these methods, the CO₂ produced during the combustion is removed from the exhaust gases by an absorption process, diaphragms, cryogenic processes or combinations thereof.
2. Methods of reducing the carbon content of the fuel: in these methods, the fuel is converted into H₂ and CO₂ before the combustion and it thus becomes possible to capture the carbon content of the fuel before entry into the gas turbine.
3. Oxy-fuel processes: in these processes, virtually pure oxygen is used as oxidizing agent instead of air, thereby resulting in a flue gas of carbon dioxide and water.

In a conventional capture process (see above variant (1)) on the output side, the CO₂ is captured after the flue gas has been expanded in the expander or the turbine of the gas turbine, i.e. the absorption pressure is 1 atm. The main disadvantage of this boundary condition consists in the fact that the CO₂ partial pressure is very low on account of the low CO₂ concentration in the flue gas (typically 3-4% by volume) and therefore large and expensive devices for removing the CO₂ are required. Although the CO₂ concentration at the stack and thus the partial pressure could be increased by partial recirculation of the flue gas to the compressor of the gas turbine (in this respect see, for example, U.S. Pat. No. 5,832,712), it remains fairly low (about 6-10% by volume).

A novel variation of the first variant which can be applied to gas-turbine cyclic processes with flue-gas recirculation shifts the location of the CO₂ separation downstream of the compressor or to an intercooling stage. As a result, the partial pressure of the carbon dioxide is markedly increased and thus the driving force for the separation is improved. In addition, the volume of the gas to be treated is considerably reduced. These two factors lead to a reduction in the size of the CO₂ separation device and its energy flows and thus reduce the costs for each tonne of carbon dioxide not emitted. In order to further reduce the delivery of carbon dioxide to the atmosphere, the combustion gases can be enriched with oxygen, a factor which permits a higher flue-gas recirculation ratio and a lower mass flow to the stack. In addition, heat sources such as the intercooling can be used for operating the separation process. This type of process control is referred to as high-pressure separation and is shown in FIGS. 2 and 3 of WO-A1-02/103176 mentioned at the beginning.

As a closer consideration of the high-pressure separation shows, the aim of this development is to increase the partial pressure of the carbon dioxide in the separation unit. If the predominant proportion of the carbon dioxide (80-95%) in the compressed working medium is removed, this results in low carbon-dioxide concentrations in the exhaust gas and consequently in the recirculation to the compressor and the carbon-dioxide separation unit. This strategy of a high separation rate reduces the quantity of the carbon dioxide which leaves the cyclic process in the exhaust gas which is not recirculated, whereas the buildup of a carbon-dioxide concentration in the cyclic process is prevented. The inlet air can certainly be enriched with oxygen in order thus to permit a higher flue-gas recirculation ratio. However, the main effect is to further limit the carbon-dioxide emissions instead of increasing the carbon-dioxide concentration. In summary, it may be said that separation of most of the carbon dioxide downstream of the compressor in a high-pressure separation leads to carbon-dioxide partial pressures which are rather on the low side during the separation, a factor which works against the development aim. Such a configuration is described in publication WO-A1-02/103176 and is covered in the following table 1 by the cases 1 and 3 for a cyclic process with air or oxygen-enriched air.

If only some of the carbon dioxide is removed in a high-pressure CO₂ separation process, it is possible to markedly increase the CO₂ partial pressure in the separation unit, in particular if the oxygen enrichment is used. Table 1 illustrates this effect, the CO₂ concentration increasing from 5% (molar) in case 3 to 14% in case 4. This increase in the concentration partly compensates for the low CO₂ separation rate and thus enables 53% of the carbon dioxide produced in the cyclic process to be captured, although only 20% of the CO₂ contained in the working medium is removed. If the cyclic process is operated exclusively with air, the buildup of the CO₂ in the cyclic process is limited by the lower quantity of recirculated flue gas; therefore the method of partial separation is less effective (see cases 1 and 2 in table 1).

Whereas the carbon-dioxide emissions increase if only some of the carbon dioxide is separated from the working medium, savings in the equipment costs through a reduction in the separation requirements and an increase in the forces driving the process can be achieved. The optimum separation effectiveness results from a compromise between the costs (if a CO₂ tax is assumed) caused by an increased carbon-dioxide emission into the atmosphere and the savings in the operating and equipment costs compared with an even better separation process.

TABLE 1

| | | CO₂ removal | CO₂ removal | Molar proportion |
|---|---|---|---|---|
| | O₂ | in separation | overall | of CO₂ to separa- |
| Case | source | unit (in %) | (in %) | tion unit |
| 1 | Air | 80 | 61 | 0.04 |
| 2 | Air | 20 | 26 | 0.08 |
| 3 | Enriched air (66% | 80 | 93 | 0.05 |
| | O₂) | | | |
| 4 | Enriched air (66% | 20 | 53 | 0.14 |
| | O₂) | | | |

The conceptual improvement of the conventional high-pressure separation has been described in the preceding section. However, further thermo-dynamic and economical improvements can be achieved by the use of a method designated as partial-flow separation. A disadvantage of the high-pressure CO₂ separation is that large heat exchangers are required in order to cool the working medium and heat it up again if a cold CO₂ separation process is used, such as, for example, “amine scrubbing”. For a good efficiency of the power station, it is important to maintain the outlet temperature of the compressor and thus keep the fuel consumption low. If it is taken into account that a low separation rate for the carbon dioxide is desirable (see above), a new separation strategy can be formulated in order to reduce the capital costs, increase the efficiency of the cyclic process and, in particular in the case of the feeding of enriched air, increase the partial pressure of the CO₂ to be removed, namely:

a high CO₂ separation rate in the case of a partial flow at the compressor outlet.

A corresponding configuration is reproduced in FIGS. 3 and 4 explained later. As can be seen from the figures, the working medium is split up into two flows downstream of the compressor. The one flow goes into the CO₂ separation process, whereas the other is fed directly to the combustor. For this reason, the inlet temperature of the combustion for the cyclic process with partial-flow separation is not reduced as much as in the full-flow case of FIGS. 1 and 2. Since only a partial flow is treated in the separation unit, this results in markedly smaller overall sizes of the heat exchangers and of the other plant parts for the process. However, the separation process itself becomes more demanding. A diaphragm may possibly be necessary in combination with the CO₂ separation process in order to reduce the transfer of contaminants into the turbomachines. If the air is enriched with an extremely pure oxygen flow, which originates, for example, from a cryogenic plant, the oxygen should be preheated in order to reduce the temperature losses of the working medium before the combustion. If intercooling is used, the dissipated heat should be used in order to regenerate the solvent (see FIG. 4). This is an important means for utilizing the heat which can normally be utilized in combined-cycle power stations.

A considerable advantage of the high-pressure separation concept over, for example, the oxy-fuel concepts consists in the fact that the existing turbomachines can be used with only slight changes. This is possible because the properties of the working medium are very similar to those in existing gas turbines. However, an inherent feature of high-pressure separation concepts is the fact that the working medium is extracted between the compressor and the turbine. If existing turbomachines are used, this means a considerable loss of power output as a consequence of both the decrease in the mass flow in the expander and the fact that the pressure into the expander must drop in order to maintain a constant volumetric flow. Consequently, the mass flow of the working medium should be increased, so that the conditions at the design point can be reestablished. This can be achieved by one of the two following measures:
oxygen injection, or
humidification.

The oxygen injection has already been explained further above as a means of limiting the CO₂ emissions. However, if it is carried out after the compression, it also serves to maintain the predetermined design conditions (pressure, mass flow) at the inlet of the expander. The humidification can be realized either by water injection, steam injection or by the use of a humidification tower. All three methods compensate for the loss of the CO₂ from the working medium by the addition of water vapor. As in the case of the oxygen injection, the predetermined design conditions at the inlet of the expander are thereby reestablished and the efficiency of the cyclic process is greatly improved. This method should be used both in the case of the conventional high-pressure separation processes and in the case of those with partial-flow separation.

### SUMMARY OF THE INVENTION

The object of the invention is to specify a method of generating energy in a power plant comprising a gas turbine, in which method carbon dioxide is removed according to the high-pressure separation concept and which is characterized by a reduced overall size of the separation devices and by reduced energy and plant costs, and to specify a power plant for carrying out the method.

The invention specifies a method with which the equipment required for a CO2 separation in a power station with semi-closed cyclic process can be reduced by high-pressure CO2 separation. In addition, the energy costs for the CO2 separation can be reduced. The invention makes use of the CO2 separation at increased pressures, i.e. downstream of the compressor or if need be between two compressor stages if intercooling is present. It is important that only some (10-70%) of the carbon dioxide in the compressed working medium is separated, so that the carbon dioxide in the cyclic process formed during the combustion can be enriched. Compared with processes having a high degree of carbon dioxide separation from the compressed working medium, the driving forces for the separation are higher and the size of the CO2 separation device can be further reduced. This leads to savings in both the equipment costs and the energy consumption of the separation process. An important modification consists in passing some of the gas from the compressor directly to the combustor and only the remainder to the CO2 separation device. Numerous advantages arise from this type of process control; thus, for example, the size of the CO2 separation device and of the gas heat exchanger can be reduced, since a smaller gas flow is processed. After the CO2 separation, the remaining partial flow can be passed to the combustor or can even be used for cooling the turbine. In both cases, the combustor inlet temperature is increased and the fuel consumption is reduced as a result, so that the thermal efficiency of the gas turbine is improved compared with previously known high-pressure separation methods.

A development of the invention presents methods which improve the power output and the plant efficiency associated with the high-pressure CO2 separation. In this case, oxygen or water vapor is added downstream of the compressor by various methods in order to compensate for the loss of working medium between compressor and expander. This permits the use of existing gas turbines for the high-pressure CO2 separation without the expander of the gas turbine having to be adapted or without other disadvantages in the case of the power output or the plant efficiency having to be accepted.

All parts of the invention are in this case intended for use in a simple gas turbine process or a combined-cycle process, provided something else is not expressly stated. The simple gas turbine process is that in which the heat of the exhaust gases from the gas turbine are not used for generating additional energy, whereas the combined-cycle process generates steam for a steam turbine by means of the exhaust gases.

A first preferred configuration of the method according to the invention is characterized in that the entire flow of the compressed gas is passed through the CO2 separator, and in that between 10% and 70% of the carbon dioxide contained in the compressed gas is removed from the compressed gas.

In this case, either the compressed gas coming from the CO2 separator is passed directly to the combustor, or the compressed gas coming from the CO2 separator first of all extracts heat in a gas/gas heat exchanger from the compressed gas coming from the first compressor and is then passed to the combustor, or the compressed gas coming from the CO2 separator is compressed further in a second compressor of the gas turbine, and the gas compressed further is fed to the combustor.

A second preferred configuration of the method according to the invention is characterized in that the entire flow of the compressed gas is split up into a larger and a smaller partial flow, and in that only the smaller partial flow is passed through the CO2 separator and more than 50%, preferably between 70% and 99%, of the carbon dioxide contained in the compressed gas is removed there from the compressed gas.

In this case, too, either the compressed gas coming from the CO2 separator is passed directly to the combustor, or the compressed gas coming from the CO2 separator first of all extracts heat in a gas/gas heat exchanger from the compressed gas coming from the first compressor and is then passed to the combustor, or the compressed gas coming from the CO2 separator is used for cooling the hot-gas duct of the turbine, or the compressed gas coming from the CO2 separator is compressed further in a second compressor of the gas turbine, and the gas compressed further is fed to the combustor.

In principle, it is advantageous that the compressed gas is cooled down in a heat exchanger before entering the CO2 separator.

Furthermore, it is conceivable for the flue gas expanded in the turbine to be cooled down in a heat exchanger or to be used in a heat-recovery steam generator for generating steam.

It is also advantageous if water is extracted in a condenser from the partial flow, recirculated to the inlet of the first compressor, of the flue gas before the mixing with the gas containing air.

Furthermore, it is conceivable for oxygen to be added to the compressed gas coming from the CO2 separator, if need be after further compression in a second compressor, and for the air used to be air enriched with oxygen.

Advantages with regard to the efficiency are obtained if the compressed gas coming from the CO2 separator is preheated in a gas/gas heat exchanger before entering the combustor by hot flue gas issuing from the turbine.

It may also be advantageous if steam is generated by means of the hot flue gas issuing from the turbine, and the generated steam is partly injected into the combustor and is partly used in the CO2 separator, and if the compressed gas coming from the CO2 separator is subsequently compressed in a booster compressor, and the subsequently compressed gas, in a gas/gas heat exchanger, exchanges heat with the compressed gas coming from the first compressor.

Furthermore, it may be advantageous if the compressed gas coming from the CO2 separator is humidified in a humidification device before entering the combustor, and the humidified gas, before entering the combustor, extracts heat in a gas/gas heat exchanger from the compressed gas issuing from the first compressor.

A first preferred configuration of the power plant according to the invention is characterized in that a single connecting line leads from the outlet of the first compressor to the first inlet of the combustor, in that the CO2 separator is inserted into this connecting line, and in that the CO2 separator is designed in such a way that it does not separate more than 70% of the carbon dioxide of the gas flowing through it.

A second preferred configuration of the power plant according to the invention is characterized in that two connecting lines lead from the outlet of the first compressor in parallel to the first inlet of the combustor, and in that the CO2 separator is inserted into one of these connecting lines.

### BRIEF DESCRIPTION OF THE DRAWINGS

The invention is to be explained below with reference to exemplary embodiments in connection with the drawing, in which:

FIG. 1 shows a simplified scheme of a power plant according to a first exemplary embodiment of the invention with single-stage compression and CO₂ separation from the full flow of the compressed gas;

FIG. 2 shows a simplified scheme of a power plant according to a second exemplary embodiment of the invention with two-stage compression with intercooling and CO₂ separation from the full flow of the compressed gas;

FIG. 3 shows a simplified scheme of a power plant according to a third exemplary embodiment of the invention with single-stage compression and CO₂ separation from a partial flow of the compressed gas;

FIG. 4 shows a simplified scheme of a power plant according to a fourth exemplary embodiment of the invention with two-stage compression with intercooling and CO₂ separation from a partial flow of the compressed gas;

FIG. 5 shows a power plant according to a fifth exemplary embodiment of the invention with single-stage compression and CO₂ separation from the full flow of the compressed gas and recuperation by means of a gas/gas heat exchanger;

FIG. 6 shows a power plant according to a sixth exemplary embodiment of the invention with CO₂ separation from the full flow of the compressed gas and also steam injection and booster compression; and

FIG. 7 shows a power plant according to a seventh exemplary embodiment of the invention with single-stage compression and CO₂ separation from the full flow of the compressed gas and humidification of the compressed gas after the CO₂ separation.

### DETAILED DESCRIPTION OF THE PREFERRED EMBODIMENTS

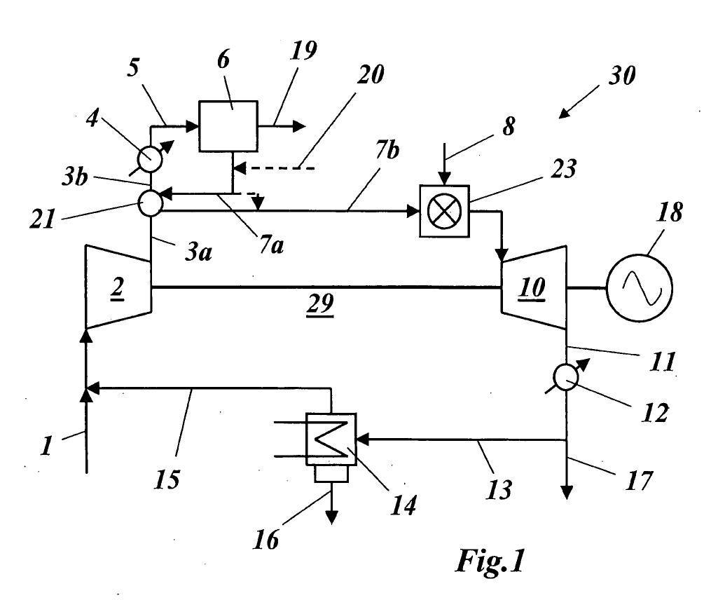

Described in the publication WO-A1-02/103176 mentioned at the beginning, as in the present FIG. 1, is a power plant 30 with a gas turbine 29, in which air or air 1 enriched with oxygen is mixed with recirculated flue gas 15 and is then passed into the compressor 2. The compressed gas 3a, 3b then flows to a heat exchanger 4, where it is cooled down to a temperature level (typically 30-60° C.) suitable for CO₂ absorption. The relatively cool compressed gas 5 then enters a CO₂ separator 6, where (and this is very important) 80-90% of the CO₂ is separated. The compressed gas 7a, 7b at the outlet of the CO₂ separator 6 is then passed to the combustor 23 and is burned there with a gaseous or liquid fuel 8, normally natural gas. The hot flue gas 9 is then expanded in a turbine (or an expander) 10, which in turn drives the compressor 2 and generates electrical energy by means of a generator 18. After the expansion in the turbine 10, the flue gas enters a heat-recovery steam generator (HRSG) 12 or is simply cooled down in a heat exchanger. The preferred procedure is to utilize a heat-recovery steam generator which is connected to a steam turbine (combined-cycle process). In this way, the power output and the efficiency of the plant is increased. Finally, a large proportion of the cold flue gas 13 is recirculated and cooled down still further in a condenser 14, so that most of the water contained is condensed and extracted as condensed water 16. The recirculated flue gas 15 is then mixed with the intake air or enriched air 1. The remainder of the cold flue gas is delivered as emitted gas 17 to a stack or the like.

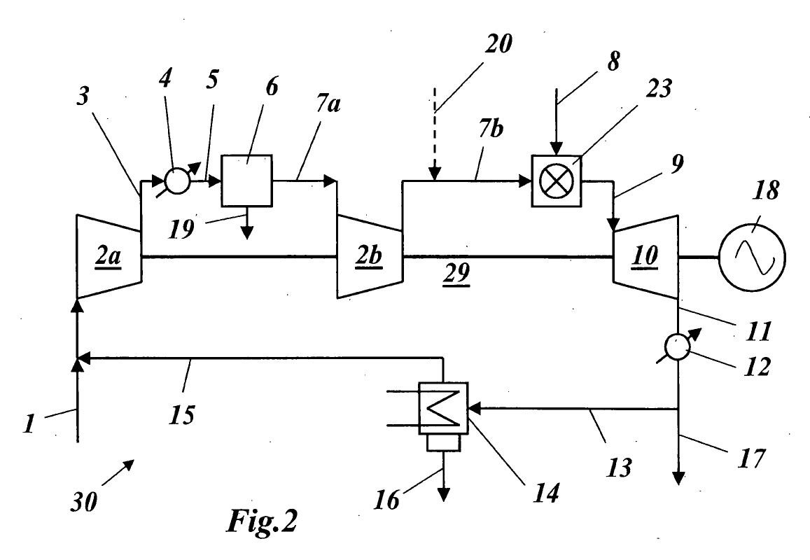

Said publication also includes a cyclic process in which the CO₂ separation takes place between two compressor stages (see FIG. 2; compressors 2a, 2b). This cyclic process makes use of “intercooling” in order to reduce the power consumption for the compressor. The basic principle of intercooling consists in first of all partly compressing the gas (compressor 2a) and then cooling it (heat exchanger 4 as intercooler) before the final compression to the desired pressure is carried out (compressor 2b). In this way, the compression work is reduced and thus the power output of the cyclic process is increased. The CO₂ separation is effected after the intercooling and before the final compression. This has two advantages over the conventional process without intercooling: the flow 3 of the compressed gas from the compressor must be cooled down in any case before the CO₂ separation (to about 30-60° C.), and this can be done during the intercooling. In other words, the intercooler fulfills two tasks at the same time; it reduces the power requirements at the compressor and at the same time cools the gas to a temperature level which is desirable for the CO₂ separation.

There is a problem with the type of process sequences described above: since the CO₂ separation rate is fairly high, the CO₂ concentration in the CO₂ separator 6 is relatively low and therefore leads to a large apparatus consuming a lot of energy.

In contrast, the invention proposes that a CO₂ separation with low efficiency be applied to the compressed working medium in order to permit higher concentrations in the CO₂ separator.

A first exemplary embodiment of the invention is shown in FIG. 1 and, as far as the scheme is concerned, is similar to the solution from publication WO-A1-02/103176 with the crucial difference that a smaller proportion of carbon dioxide (about 10-70%) is removed from the compressed working medium. This separation strategy produces a substantially higher CO₂ concentration during the separation process, in particular during the feeding of air enriched with oxygen, and thus reduces the separation requirements imposed on the process. Compared with the conventional high-pressure separation concept, these factors reduce the size of the requisite equipment and the requisite energy flows and thus the costs. Additionally provided in FIG. 1 is a gas/gas heat exchanger 21, in which the compressed gas 3a delivers heat to the compressed gas 7a coming from the CO₂ separator 6. The separated CO₂ 19 can be disposed of in a known manner or treated in another way.

In the same manner, a second exemplary embodiment of the invention (FIG. 2), as far as the scheme is concerned, is similar to the second process of WO-A1-02/103176. Here, too, the essential difference again consists in the fact that the carbon dioxide is removed with markedly lower effectiveness from the compressed working medium. In addition, the heat, extracted in the intercooler, in the CO₂ separation column can be used to regenerate the solvent if the CO₂ separation is based, for example, on amine scrubbing. This means that less steam, or in the best case no steam, from the steam circuit is required for the CO₂ separation process. As in the first exemplary embodiment, these factors reduce the size of the equipment and the requisite energy flows and thus the costs, compared with the conventional high-pressure separation concepts.

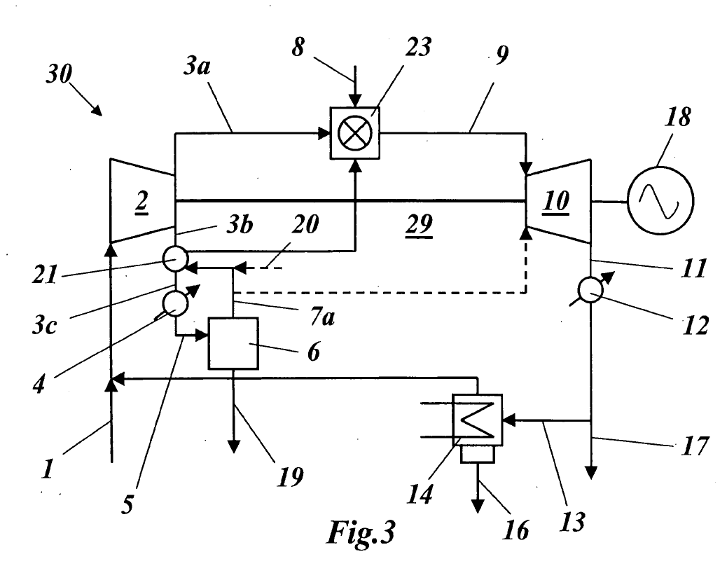

The third exemplary embodiment of the invention relates to a refined configuration for carrying out the carbon dioxide separation described in the case of the first exemplary embodiment. In this example, a low separation rate is achieved by only a partial flow (10-90%) of the working medium being subjected to the separation process (see FIG. 3) and by a much more predominant portion (70-99%) of the carbon dioxide present being removed in this partial flow. The gas flow downstream of the compressor 2 is split up and a first partial flow 3a of the compressed gas is passed directly to the combustor 23, whereas a second partial flow 3b of the compressed gas is passed on to the CO₂ separator 6. By this type of procedure, the size and costs of the CO₂ separation device can be further reduced compared with the first exemplary embodiment of the invention. The concept also limits the thermodynamic losses by minimizing the temperature drop between the outlet of the compressor 2 and the inlet of the combustor 23. Therefore less fuel has to burn in order to achieve the desired combustion temperature, and the efficiency is higher compared with the full-flow arrangement of FIG. 1. A modification of the concept consists in using a portion of the low-CO₂ gas issuing from the CO₂ separator in order thus to cool the hot-gas duct of the turbine 10 (dashed arrow leading to the turbine 10 in FIG. 3). This has the thermodynamic advantage that the mass flow required for cooling the turbine is reduced by the reduction in the temperature of the delivered gas, whereas at the same time the inlet temperature of the combustion remains unaffected by the separation process.

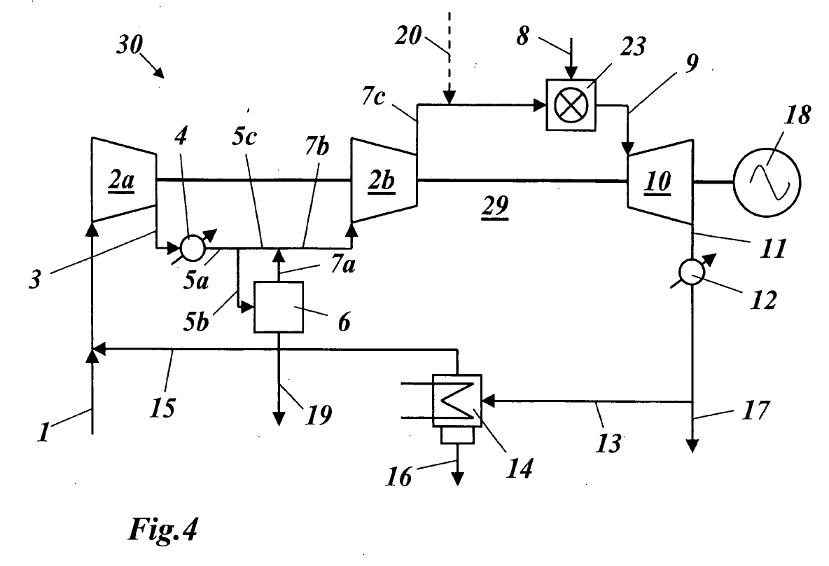

A fourth exemplary embodiment of the invention uses the partial-flow configuration of the third exemplary embodiment described above and applies it to the configuration according to the second exemplary embodiment of the invention, i.e. the gas-turbine cyclic process with intercooling (FIG. 4). The mixture of air (or oxygen-enriched air) 1 and recirculated flue gas 15 is first of all compressed in a first compressor 2a and then cooled down (heat exchanger or intercooler 4). A partial flow 5b of the compressed gas 5a flows to the CO₂ separator 6, where a much more predominant portion (80-99%) of the carbon dioxide is removed. The compressed gas 7a treated in this way and the compressed gas 5c which is not treated are brought together again and delivered into a second compressor 2b, where they are compressed to the desired working pressure and then pass as compressed gas 7c to the combustor 23. As in the improvement from the first exemplary embodiment to the third exemplary embodiment, the requirements for the energy and the equipment for the CO₂ separation are reduced compared with the second exemplary embodiment by this type of process control. Here, too, the heat extracted during the intercooling can be used in the CO₂ separation column in order to minimize the thermodynamic effect of the separation process.

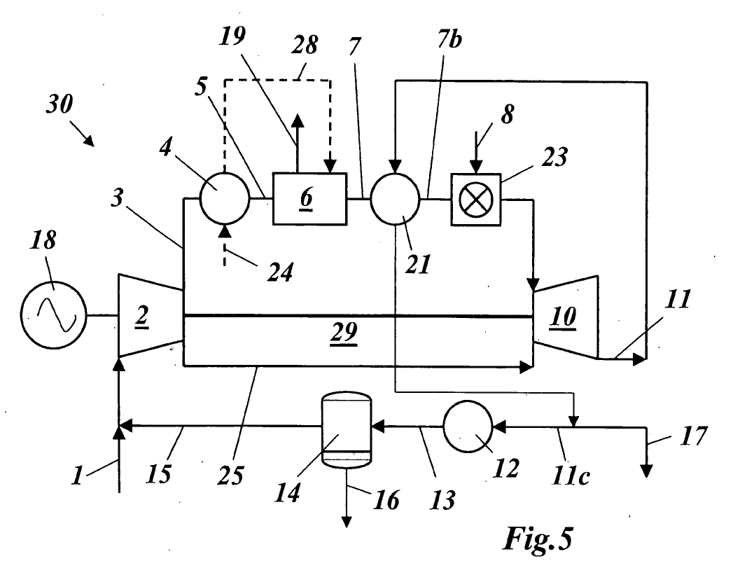

A fifth exemplary embodiment of the invention relates to a high-pressure CO₂ separation process with recuperation (FIG. 5). In this case, for heating the compressed gas 7 which leaves the CO₂ separator 6, the hot flue gas 11 from the expander (turbine) 10 of the gas turbine 29 is used in a gas/gas heat exchanger or recuperator 21 and issues as flue gas 11b. Another partial flow 11c of the flue gas 11 is cooled down in a heat exchanger 12, water is extracted from the cold flue gas 13 in a condenser 14 and said flue gas is mixed as recirculated flue gas 15 with the intake air 1. As a result, the temperature toward the combustor 23 can be increased on account of the higher temperature, compared with the compressor outlet temperature, at the outlet of the turbine 10. This means that less fuel has to be burned in order to achieve the desired combustion temperature and that the efficiency of the plant thus increases. A further advantage of this concept is that the overall size of the gas/gas heat exchanger or recuperator 21 can be reduced, since the driving force of the temperature in this case is greater compared with the previous cases. The only real disadvantage in this method configuration is that it can only be applied to simple cyclic processes and not to combined cyclic processes. The reason for this can be seen in the fact that the temperature from the recuperator is much too low for effective utilization in a heat-recovery steam generator. The dashed arrow in FIG. 5 indicates that water 24 may be optionally converted into steam 28 in the heat exchanger 4 by the compressed gas 3, and the steam may be optionally used in the CO₂ separator 6.

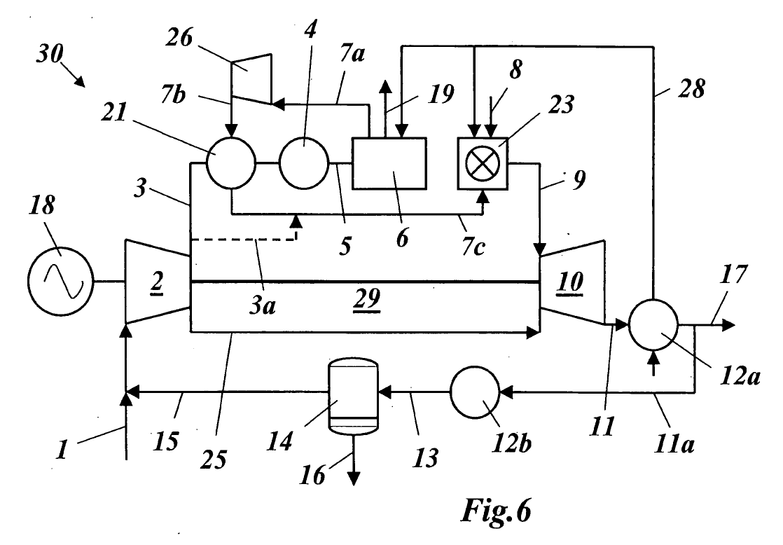

A sixth exemplary embodiment of the invention makes use of the steam injection into the gas turbine 29 for increasing the outlet temperature of the high-pressure CO₂ separation process (FIG. 6). Since some of the working medium (CO₂ and water) is removed from the compressed gas, the mass flow of the compressed gas 7c into the turbine 10 decreases; as a result, the pressure at the inlet of the turbine 10 drops. This leads to a decrease in the output produced in the turbine 10. One possibility of avoiding this consists in carrying out a steam injection before the expansion in the turbine 10. In order to convert modern gas turbines to the novel high-pressure CO₂ separation concept with steam injection, it may be necessary to insert a booster compressor 26 between the CO₂ separator 6 and the gas/gas heat exchanger 21. The booster compressor 26 subsequently compresses the compressed gas 7a coming from the CO₂ separator 6, and the subsequently compressed gas 7b, in the gas/gas heat exchanger 21, exchanges heat with the compressed gas 3 coming from the compressor 2 and is then passed as flow 7c to the combustor 23. In the best cast, the injected steam 28, which is generated by the hot flue gas in a heat exchanger or steam generator 12a, increases the inlet pressure of the turbine 10 to the nominal pressure. This means, in conjunction with the pressure losses in the heat exchangers 4 and 21 and the CO₂ separator 6 between the compressor 2 and the turbine 10, that the compressor has to deliver a higher pressure than that for which it is actually designed. The surge margin of the compressor may be put at risk as a result. One possibility therefore consists in providing a booster compressor 26 which sufficiently increases the pressure in order to compensate for the pressure loss in the plant parts referred to. The steam for the injection can be generated by the heat sources of the cyclic process, such as, for example, the flue gas or even the hot compressed gas at the outlet of the compressor. This method can be applied to the first to fifth exemplary embodiments of the invention, i.e. in combination with the full-flow or partial-flow CO₂ separation with intercooling and recuperation.

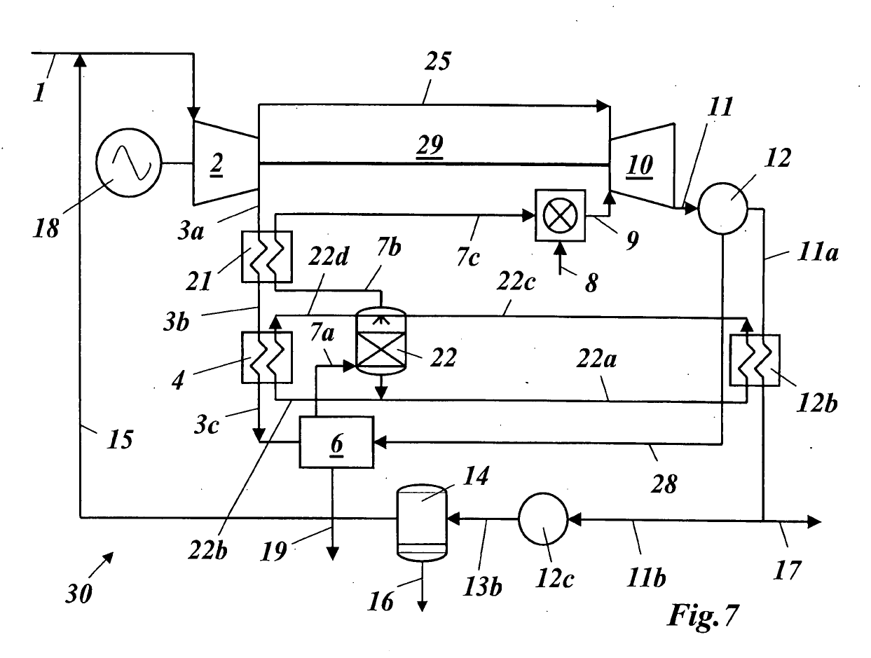

A seventh exemplary embodiment of the invention is very similar to the sixth exemplary embodiment discussed above; however, instead of the steam injection, the working medium in this process is humidified in a humidification device (humidification tower 22) arranged upstream of the combustor (FIG. 7). The difference between the steam injection and the humidification lies in the fact that low-grade energy can be used for the humidification in the last-mentioned case and thus increases the efficiency of the plant. Cold water 22a, b is heated in the heat exchangers 4 and 12b by the compressed gas 3a, b and the hot flue gas 11a and, as warm water 22c, d, is brought into contact with the working medium in counterflow in a packed bed in the humidification tower 22. Some of the water evaporates and the water flowing down in the tower is cooled. As already mentioned, the energy for heating the water can be extracted from the flue gas 11a, or from the compressed gas 3a, b, c entering the CO₂ separator 6, or from an intercooler present in the cyclic process (see FIGS. 2 and 4). The advantage of using low-grade energy for the evaporation is even more distinct for combined-cycle plants, where it is necessary in the case of steam injection to branch off the steam which would otherwise be used in the steam turbine. This method can be applied to the first to fifth exemplary embodiment of the invention, i.e. in combination with the full-flow and partial-flow CO₂ separation with intercooling and recuperation.

In all the concepts described, the CO₂ separation processes could comprise, for example, a chemical absorption process which uses an amine-based solvent or a sodium carbonate solvent or the like. In a conventional manner, the working medium would be brought into contact with the solvent in an absorption tower, where CO₂ is transformed from the gas to the liquid phase and a low-CO₂ gas emerges. Alternatively, a diaphragm can act as contact element. This has the advantage that the two flows are kept separate and transfer of the solvent into the gas flow is prevented and thus the turbomachines are protected. In addition, the overall size, weight and costs can be reduced. The solvent issuing from the absorber or the diaphragm unit and enriched with CO₂ is regenerated in a separation column and recirculated in order to be used again. Other examples for a CO₂ separation process are the physical absorption, combinations of chemical and physical absorption, adsorption on solid bodies, and combinations thereof.

A dashed arrow in FIGS. 1 to 4 indicates that oxygen 20 can be added to the process after the CO₂ separation and if need be after further compression in a second compressor 2b, as has already been explained at the beginning.

List of Designations
1 Air (or enriched air)
2, 2a, 2b Compressor
3, 3a, 3b, 3c Compressed gas
4 Heat exchanger
5, 5a, 5b, 5c Compressed gas
6 CO₂ separator
7, 7a, 7b, 7c Compressed gas
8 Fuel
9 Hot flue gas
10 Expander (turbine)
11, 11a, 11b, 11c Flue gases
12, 12a, b Heat exchanger, heat-recovery steam generator (HRSG)
13 Cold flue gas
14 Condenser
15 Recirculated flue gas
16 Condensed water
17 Emitted flue gas
18 Generator
19 Separated CO₂
20 Oxygen
21 Gas/gas heat exchanger
22 Humidification tower
22a, 22b Cold water
22c, 22d Hot water
23 Combustor
24 Water
25 Cooling air
26 Booster compressor
27 CO₂
28 Steam
29 Gas turbine
30 Power plant

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A method of generating energy in a power plant including a gas turbine, the method comprising:
first compressing a gas containing air in a first compressor of the gas turbine;
second feeding the compressed gas to a combustion process with fuel in a combustor to generate hot flue gas;
third expanding the hot flue gas from the combustor in an expander or a turbine, and driving a generator, of the gas turbine while performing work; and
fourth recirculating at least a partial flow of the expanded flue gas to an inlet of the first compressor and admixing with the gas containing air, and separating carbon dioxide (CO₂) from the compressed gas in a CO₂ separator before said expanding;
wherein separating comprises removing from the compressed gas not more than about 70% of the carbon dioxide contained in the compressed gas to permit increased CO₂ concentrations in the CO₂ separator.

2. The method as claimed in claim 1, wherein recirculating comprises recirculating the entire flow of the compressed gas through the CO₂ separator, and wherein removing comprises removing between 10% and 70% of the carbon dioxide contained in the compressed gas.

3. The method as claimed in claim 1, comprising:
splitting up the entire flow of the compressed gas into a larger partial flow and a smaller partial flow, and passing only the smaller partial flow through the CO₂ separator and removing from the compressed gas more than 50% of the carbon dioxide contained in the compressed gas.

4. The method as claimed in claim 1, comprising:
cooling down the compressed gas in a heat exchanger before entering the CO₂ separator.

5. The method as claimed in claim 1, comprising:
cooling down the flue gas expanded in the turbine in a heat exchanger, or using the flue gas expanded in the turbine in a heat-recovery steam generator for generating steam.

6. The method as claimed in claim 1, comprising:
extracting water in a condenser from the at least partial flow of the flue gas before mixing with the gas containing air.

7. The method as claimed in claim 2, comprising:
passing the compressed gas from the CO₂ separator directly to the combustor.

8. The method as claimed in claim 2, comprising:
extracting heat with the compressed gas coming from the CO₂ separator first in a gas/gas heat exchanger from the compressed gas from the first compressor, and after said extracting heat passing said compressed gas to the combustor.

9. The method as claimed in claim 2, comprising:
compressing the compressed gas coming from the CO₂ separator further in a second compressor of the gas turbine; and
feeding the further compressed gas to the combustor.

10. The method as claimed in claim 3, comprising:
passing the compressed gas coming from the CO₂ separator directly to the combustor.

11. The method as claimed in claim 3, comprising: extracting heat with the compressed gas coming from the CO₂ separator first in a gas/gas heat exchanger from the compressed gas coming from the first compressor, and after said extracting heat passing said compressed gas to the combustor.

12. The method as claimed in claim 3, comprising:
cooling a hot-gas duct of the turbine with the compressed gas coming from the CO₂ separator.

13. The method as claimed in claim 3, comprising:
compressing the compressed gas coming from the CO₂ separator further in a second compressor of the gas turbine; and
feeding the further compressed gas to the combustor.

14. The method as claimed in claim 1, comprising:
further compressing the compressed gas coming from the CO₂ separator in a second compressor; and
optionally adding oxygen to the further compressed gas.

15. The method as claimed in claim 1, wherein said air comprises air enriched with oxygen.

16. The method as claimed in claim 1, comprising:
preheating compressed gas coming from the CO₂ separator in a gas/gas heat exchanger before entering the combustor, with hot flue gas issuing from the turbine.

17. The method as claimed in claim 1, comprising:
generating steam with hot flue gas issuing from the turbine; and
injecting a portion of the generated steam into the combustor, and using a portion of the generated steam in the CO₂ separator.

18. The method as claimed in claim 17, comprising:
compressing the compressed gas coming from the CO₂ separator subsequently in a booster compressor; and
exchanging heat between the subsequently compressed gas and the compressed gas coming from the first compressor, in a gas/gas heat exchanger.

19. The method as claimed in claim 1, comprising:
humidifying compressed gas coming from the CO₂ separator in a humidification device before entering the combustor; and
extracting heat with the humidified gas, before entering the combustor, in a gas/gas heat exchanger from compressed gas issuing from the first compressor.

20. A power plant useful for carrying out the method as claimed in claim 1, comprising:
a gas turbine having
a first compressor with an inlet and outlet,
a combustor having a first inlet for compressed gas, a second inlet for fuel, and an outlet for hot flue gas,
a condenser having an inlet and an outlet, and
a turbine with an inlet and outlet, the outlet of the combustor being connected to the inlet of the turbine, the outlet of the turbine being connected via the condenser to the inlet of the first compressor, and the outlet of the first compressor being connected to the first inlet of the combustor;
a heat exchanger; and
a CO₂ separator having an inlet side connected to the outlet of the first compressor via the heat exchanger, and having an outlet side connected to the first inlet of the combustor;
wherein the CO₂ separator is configured and arranged to separate not more than 70% of the carbon dioxide of the compressed gas coming from the first compressor.

21. The power plant as claimed in claim 20, further comprising:
a single connecting line leading from the outlet of the first compressor to the first inlet of the combustor;
wherein the CO₂ separator is positioned in said single connecting line; and
wherein the CO₂ separator is configured and arranged so that the CO₂ separator separates not more than 70% of the carbon dioxide of the gas flowing therethrough.

22. The power plant as claimed in claim 20, further comprising:
two connecting lines leading from the outlet of the first compressor in parallel to the first inlet of the combustor; and
wherein the CO₂ separator is positioned in one of said two connecting lines.

23. The power plant as claimed in claim 20, wherein said heat exchanger comprises a first heat exchanger, and further comprising:
a second heat exchanger or a heat-recovery steam generator arranged between the outlet of the turbine and the inlet of the condenser.

24. The power plant as claimed in claim 20, further comprising:
a second compressor arranged between the outlet of the CO₂ separator and the first inlet of the combustor.

25. The power plant as claimed in claim 20, further comprising:
a gas/gas heat exchanger connected to the outlet of the turbine and arranged between the outlet of the CO₂ separator and the first inlet of the combustor.

26. The power plant as claimed in claim 20, further comprising:
a device for generating steam arranged at the outlet of the turbine and connected to the combustor and to the CO₂ separator; and
a booster compressor and a following gas/gas heat exchanger arranged between the outlet of the CO₂ separator and the first inlet of the combustor.

27. The power plant as claimed in claim 20, further comprising:
a humidification device arranged between the outlet of the CO₂ separator and the first inlet of the combustor.

28. The method as claimed in claim 3, wherein removing comprises removing from the compressed gas between 70% and 99% of the carbon dioxide contained in the compressed gas.
